(19) United States
(12) Patent Application Publication
(10) Pub. No.: US 2025/0033645 A1
(43) Pub. Date: Jan. 30, 2025

(54) OFF-ROAD TRAVEL ASSISTIVE DEVICE

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Jun Han Kang, Seoul (KR); Ik Jin Um, Busan (KR); Ji Hun Byun, Hwaseong-si (KR); Man Dong Kim, Hwaseong-si (KR); Jung Ho Park, Incheon (KR); Jin Soo Seo, Suwon-si (KR); Chan Uk Yang, Seoul (KR); Seung Won Choi, Seoul (KR); Hyuk Ju Shon, Seoul (KR); Kun Soo Huh, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 18/524,601

(22) Filed: Nov. 30, 2023

(30) Foreign Application Priority Data
Jul. 24, 2023 (KR) 10-2023-0096371

(51) Int. Cl. B60W 40/06; B60W 30/18; B60W 50/14

(52) U.S. Cl. CPC B60W 40/06; B60W 30/18172; B60W 50/14; B60W 2050/143; B60W 2050/146; B60W 2510/1005; B60W 2520/06; B60W 2520/10; B60W 2520/105; B60W 2520/26; B60W 2552/05

(57) ABSTRACT

An off-road travel assistive device includes a receiver configured to receive travel data of a vehicle, and an estimator. The estimator includes a road surface severity estimator configured to estimate road surface severity data based on the travel data of the vehicle. The device also includes a stuck probability determiner configured to determine probability of a stuck state of the vehicle occurring using the travel data and the road surface severity data. The stuck probability determiner determines stuck probability using a meta-model.

### CROSS-REFERENCE TO RELATED APPLICATION(S)

This application claims the benefit of and priority to Korean Patent Application No. 10-2023-0096371 filed on Jul. 24, 2023, the disclosure of which is incorporated herein by reference in its entirety.

### BACKGROUND

### 1. Technical Field

The present disclosure relates to an off-road travel assistive device.

### 2. Description of Related Art

The number of people who enjoy camping and participating in off-road traveling leisure sports, using vehicles, is continuously increasing. Accordingly, there is a need for technology that allows for traveling comfortably and safely on unpaved off-roads other than paved roads. Accordingly, various vehicle traveling control modes are being developed to assist in the traveling control of vehicles specialized for off-road travel.

When a vehicle travels off-road, it may be important to drive the vehicle so that it does not get into a stuck state. In this case, the stuck state refers to a state in which a vehicle is stuck on a road and cannot move. When a vehicle gets stuck, not only may it become impossible to move the vehicle, but it may also be very difficult to dislodge the stuck vehicle. In particular, for an inexperienced driver, the more the driver attempts to get out of a stuck state, the more severely the vehicle may become stuck. Often, only an external force provided by a tow truck or the like may be used to eventually release a stuck vehicle from the stuck state.

Therefore, when a vehicle travels off-road such as on an unpaved road or the like, it is important that the vehicle avoids a stuck state. The stuck state refers to a situation in which the vehicle is unable to move on a road surface.

### SUMMARY

Embodiments of the present disclosure provides a device that determines a possibility that a moving vehicle gets struck on a road (hereinafter “a stuck probability”). When it is determined that the stuck probability is high, before a stuck state occurs, the device informs a driver of a determined result such that the driver is alerted to travel with caution to prevent the vehicle from being stuck, or to change traveling to have a preset autonomous traveling control mode by the driver to assist in off-road traveling to prevent the vehicle from being stuck.

Additionally, in performing off-road traveling, a driving habit, a traveling condition, or the like of a driver may complicatedly affect a stuck state of a vehicle. For example, when a vehicle is stuck, various variables such as a speed of the vehicle, a wheel slip rate of the vehicle, an accelerator open value of the vehicle, or the like, may be complicatedly affected, not sequentially.

Therefore, there is a need to assist a user with off-road traveling by selecting important variables that may affect occurrence of a stuck state of a vehicle, reflecting the selected variables as a whole to determine stuck probability, and providing data related thereto.

There is a method of using a rule-based model as a method of determining a specific state using various variable data. The rule-based model may be bound to be greatly influenced by an order of determining rules, priority, or the like. Therefore, there is a problem that it may be difficult to use in determining stuck probability, making it difficult to prioritize, due to complex effects of a driving habit, a traveling condition, or the like of a driver.

Therefore, there is a need to develop a technology that may more accurately determine stuck probability of a vehicle, which is traveling off-road, by comprehensively considering various traveling variables.

In order to solve at least some of the above problems, the purpose of the present disclosure may be to provide an off-road travel assistive device accurately for determining stuck probability of a vehicle before the vehicle is stuck, and using the stuck probability.

As another aspect, the purpose of the present disclosure may be to provide an off-road travel assistive device informing a driver of stuck probability of a vehicle, to alert the driver to travel with caution to prevent the vehicle from being stuck, or to change traveling to have a preset autonomous traveling control mode by the driver to prevent the vehicle from being stuck.

According to an aspect of the present disclosure, an off-road travel assistive device includes a receiver configured to receive travel data of a vehicle, and a road surface severity estimator configured to estimate road surface severity data based on the travel data of the vehicle. Additionally, the device may include a stuck probability determiner configured to determine a probability of a stuck state of the vehicle occurring by using the travel data and the road surface severity data.

The travel data may include at least one of an accelerator open value of the vehicle, a wheel slip rate of the vehicle, a steering angle of the vehicle, a currently traveling gear ratio of the vehicle, a speed of the vehicle, or a type of road surface.

The road surface severity estimator may estimate road surface severity using a deep-learned road surface severity estimation model. The road surface severity estimation model may estimate a road surface having stuck probability that is higher than a preset standard, as a deep road surface, and may estimate a road surface having stuck probability that is lower than the preset standard, as a shallow road surface.

The road surface severity estimation model may estimate the road surface severity as a score having a predetermined range.

The off-road travel assistive device may further include a start condition determiner configured to determine whether the travel data satisfies a preset start condition for determining the stuck probability.

The starting condition may be determined based on at least one of a steering angle of the vehicle, a current gear state of the vehicle, or a speed of the vehicle.

The stuck probability determiner may determine the stuck probability using a meta-model. The meta-model may score the stuck probability using at least one parameter determined by including at least one of a speed of the vehicle, a wheel slip rate of the vehicle, an accelerator open value of the vehicle, or road surface severity.

The meta-model may include a plurality of parameters determined by the speed of the vehicle, the wheel slip rate of the vehicle, the accelerator open value of the vehicle, and the road surface severity. The meta-model may score the stuck probability as a product of the plurality of parameters.

The meta-model may include a plurality of parameters determined by the speed of the vehicle, the wheel slip rate of the vehicle, the accelerator open value of the vehicle, and the road surface severity. The meta-model may score the stuck probability as a sum of the plurality of parameters.

When the vehicle is controlled to travel autonomously, the meta-model may score the stuck probability using the at least one parameter determined by including at least one of a speed of the vehicle, a wheel slip rate of the vehicle, an accelerator open value of the vehicle, or road surface severity.

The meta-model may change the parameter(s) that scores the stuck probability depending on a type of road surface on which the vehicle is traveling.

The off-road travel assistive device may further include a post-processor configured to post-process the stuck probability determined by the stuck probability determiner using an exponential moving average (EMA).

The post-processor may apply a second exponential constant value when the stuck probability determined by the stuck probability determiner is greater than a preset score. The post-processor may also apply a first exponential constant value when the stuck probability determined by the stuck probability determiner is lower than the preset score. The first exponential constant value may be set to be greater than the second exponential constant value.

The off-road travel assistive device may further include a stuck mode determiner applying a stuck mode based on a stuck probability score received from the stuck probability determiner.

The off-road travel assistive device may further include a notification unit configured to inform a driver of a traveling status using at least one of a display or a sound. The stuck mode determiner may inform the driver of the stuck probability through the notification unit when the stuck probability score is greater than a preset score.

In changing the stuck mode, the stuck mode determiner may apply, such that a reference score for changing from a lower stuck mode to an upper stuck mode is set to be higher than a reference score for changing from the upper stuck mode to the lower stuck mode. The upper stuck mode may be a mode in which stuck occurrence probability is higher than the lower stuck mode.

According to another aspect of the present disclosure, an off-road travel assistive device includes a receiver configured to receive travel data of a vehicle, and an estimator including a road surface severity estimator configured to estimate road surface severity data based on the travel data of the vehicle. The device may further include a stuck probability determiner configured to determine probability of a stuck state of the vehicle occurring by using the travel data and the road surface severity data. The stuck probability determiner determines the stuck probability using the travel data of the vehicle and the road surface severity data. The travel data includes at least a speed of the vehicle, a wheel slip rate of the vehicle, or data regarding an accelerator open value of the vehicle.

The travel data may further include at least one of a steering angle of the vehicle, a current traveling gear ratio of the vehicle, or a type of road surface.

The road surface severity estimator may estimate the road surface severity as a score in a preset range based on stuck occurrence probability depending on a road surface condition.

The estimator may further include a traveling speed estimator configured to estimate an off-road traveling speed using a deep-learned wheel slip rate estimation model. The traveling speed estimator may estimate a wheel slip rate using the travel data and the wheel slip rate estimation model, and may estimate the off-road traveling speed using the estimated wheel slip rate. The speed of the vehicle may include the off-road traveling speed.

The off-road travel assistive device may further include a start condition determiner configured to determine the stuck probability using the stuck probability determiner when the travel data satisfies a preset start condition. The start condition determiner may not determine the stuck probability when the vehicle travels with a sharp turn, travels in reverse, or stops.

The stuck probability determiner may score the stuck probability using the at least one parameter determined by including at least one of the speed of the vehicle, the wheel slip rate of the vehicle, the accelerator open value of the vehicle, or the road surface severity.

The off-road travel assistive device may further include a post-processor configured to reflect the stuck probability determined in the past to the stuck probability determined by the stuck probability determiner, and post-process a result therefrom.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a schematic diagram of a wheel of a vehicle traveling off-road.

FIG. 2 is a block diagram of an off-road travel assistive device according to an embodiment of the present disclosure.

FIG. 3 is a flowchart of a method for estimating stuck probability according to an embodiment of the present disclosure.

FIG. 4 is a detailed flowchart of S1020 of FIG. 3 according to an embodiment of the present disclosure.

FIG. 5 is a flowchart illustrating a process of applying an exponential moving average of a post-processor according to an embodiment of the present disclosure.

### DETAILED DESCRIPTION

Because the present disclosure may have various changes and may have various embodiments of the present disclosure, specific embodiments may be illustrated in the drawings and described in detail. However, this may not be intended to limit the present disclosure to specific embodiments, and instead it should be understood to include all modifications, equivalents and substitutes included in the spirit and scope of the present disclosure.

Terms such as first, second, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific embodiments, and may not be intended to limit the present disclosure. The singular expression may include the plural expression unless the context clearly dictates otherwise. In the present application, terms such as “comprise” or “have” may be intended to designate that a feature, number, step, operation, component, part, or combination thereof described in the specification exists, but one or more other features. It should be understood that this does not preclude the existence or addition of numbers, steps, operations, components, parts, or combinations thereof.

Unless defined otherwise, all terms used herein, including technical or scientific terms, include the same meaning as commonly understood by one having ordinary skill in the art to which the present disclosure belongs. Terms such as those defined in a commonly used dictionary should be interpreted as having a meaning consistent with the meaning in the context of the related art. The terms should not be interpreted in an ideal or excessively formal meaning unless explicitly defined in the present application.

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in more detail with reference to the accompanying drawings.

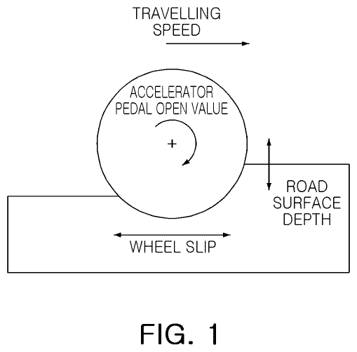

FIG. 1 is a schematic diagram of a wheel of a vehicle traveling off-road.

Data required to determine stuck occurrence probability of a vehicle is illustrated as an example. An off-road travel assistive device according to an embodiment of the present disclosure may make judgments using a speed of the vehicle, an accelerator open value of the vehicle, a wheel slip rate of the vehicle, and road surface severity.

In this case, the road surface severity may be a concept including a road surface depth, road surface condition data, or the like. For example, the road surface severity may be estimated by considering a hard sandy road surface, a scattered sandy road surface, a severely curved or uneven road surface, or the like. In addition, in a muddy road surface, e.g., a muddy clay road surface, the road surface severity may be estimated by considering a depth at which a wheel is submerged in clay mud, the stickiness of the clay mud, or the like. Additionally, in a case of a muddy mountain road surface, the road surface severity may be estimated by considering a location, a size, or the like of a stone or a rock.

In this case, the road surface severity may be expressed using a concept of road surface depth. A road surface having a high stuck occurrence probability (i.e., a road surface having a high probability of getting a vehicle stuck) due to a harsh road surface condition may be called a deep road surface. In addition, a road surface having a low stuck occurrence probability (i.e., a road surface having a low probability of getting a vehicle stuck) due to a non-harsh road surface condition may be called a shallow road surface.

For example, the deep road surface and the shallow road surface may be a concept containing data not only about a depth of the road surface, but also about a condition of the road surface (e.g., a hard sandy road surface, a scattered sandy road surface, a thin clay road surface, a sticky clay road surface, a small gravel road surface, a large rock road surface, or the like).

For example, when the vehicle travels on a sandy road surface, in a relatively hard sandy road surface on which a small amount of sand is accumulated, an amount of locking or slipping of the wheel of the vehicle may be relatively small to the decrease stuck occurrence probability. In this case, a road surface having low stuck occurrence probability may be referred to as a shallow road surface.

When the vehicle travels on a sandy road surface, in a sandy road surface in which a large amount of sand is accumulated and the wheel is easily submerged, the stuck occurrence probability may increase. In this case, a road surface having high stuck occurrence probability may be referred to as a deep road surface.

For example, even when traveling on the same sandy road surface, there may be a road surface having high stuck occurrence probability, and a road surface having low stuck occurrence probability. A detailed description of the method for estimating road surface severity data is provided below.

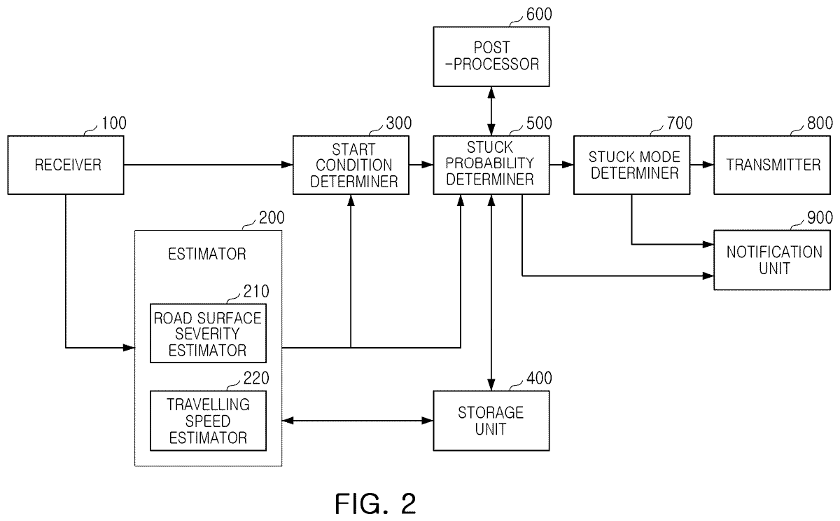

FIG. 2 is a block diagram of an off-road travel assistive device according to an embodiment of the present disclosure.

Referring to FIG. 2, an off-road travel assistive device according to an embodiment of the present disclosure may include a receiver 100, an estimator 200, a start condition determiner 300, a stuck probability determiner 500, a stuck mode determiner 700, a storage unit 400, a post-processor 600, a transmitter 800, and a notification unit 900.

The receiver 100 may receive data regarding a traveling state of a vehicle. For example, the receiver 100 may receive data regarding a traveling state including an accelerator open value of the vehicle, a wheel slip rate of the vehicle, a steering angle of the vehicle, a current traveling gear ratio of the vehicle, a speed of the vehicle, a type of road surface, road surface severity, or the like.

The receiver 100 may be connected to sensors provided in the vehicle using a network provided in the vehicle. The receiver 100 may also receive data regarding the traveling state of the vehicle. For example, the receiver 100 may receive accelerator open value data from an accelerator pedal sensor (an acceleration position sensor (APS)) using a controller area network (CAN) of the vehicle.

The start condition determiner 300 may determine whether to start determination of the stuck probability determiner 500, based on the traveling state of the vehicle. The start condition determiner 300 may not determine the stuck probability (i.e., the probability of a vehicle being stuck) when the stuck probability of the vehicle is very low or when the vehicle is in a traveling state in which it is difficult to accurately determine the stuck probability.

For example, the start condition determiner 300 may not determine the stuck probability of the vehicle, in a traveling state, similar to a traveling state in which the vehicle stops (e.g., in a case in which the speed of the vehicle is 1.5 kilometers per hour (km/h) or less), in a state in which the vehicle is turning (e.g., in a case in which the steering angle is 360 degrees or more), and in a state in which the vehicle is reversing (e.g., in a case in which a gear state of the vehicle is in reverse gear).

The estimator 200 may estimate additional travel data, based on data regarding the traveling state received from the receiver 100. The estimator 200 may further include a road surface severity estimator 210 and a traveling speed estimator 220.

In this case, the road surface severity may be a concept including stuck probability depending on a road surface condition on which the vehicle travels. The road surface severity may be a numerical expression of the stuck probability of the vehicle, depending on the road surface condition on which the vehicle travels.

The road surface severity estimator 210 may estimate the road surface severity using a road surface severity estimation model, which may be learned using deep learning.

The deep learning may train a machine to distinguish objects by a computer by way of imitating a data processing method in which a human brain discovers patterns in a large amount of data and then distinguishes the objects. By applying deep learning technology, the computer may be able to recognize, reason, and make determinations by itself, without humans having to set all judgment standards.

A neural network may be a type of deep learning network, and may be a network structure that mimics that of the human brain. The neural network may extract ‘feature values’ of objects, and may be trained in a similar manner to humans. The neural network may calculate the feature values, rather than rules suggested by humans, in order to identify the objects.

The neural network may include an input layer, an output layer, and an intermediate layer. The intermediate layer may be known as a hidden layer. The presence of the intermediate layer may increase the number of layers of neuron groups responsible for processing. A deep neural network may be said to have a multiple neuron layer in the intermediate layer. Machine learning performed on the deep neural network may be referred to as deep learning.

The intermediate layer may be further layered to train and process more data. When the intermediate layer is excessively layered, the number of parameters may also increase, the neurons may be numerous and complex, and unrelated combinations may increase, leading to over-fitting. The over-fitting may cause performance to deteriorate. A convolution neural network (CNN) may solve the problems.

The convolutional neural network may be a type of multilayer perceptron designed to use minimal preprocessing. The CNN may include one or several convolution layers and general artificial neural network layers thereon. The CNN may additionally utilize a weight and pooling layers. The CNN may fully utilize input data having a two-dimensional structure.

A recurrent neural network (RNN), which exhibits high performance in time series data analysis, may include an input layer, an intermediate layer, and an output layer. A value of a current intermediate layer may affect the calculation of the following output layer. The recurrent neural network may be a type of artificial neural network in which nodes in the intermediate layer are connected to an edge having directivity, to form a directed cycle.

Time series data may be data in which observed values may be recorded at regular intervals over time. Unlike static data, the time series data may have many characteristics. For example, there may be time series data that changes relatively smoothly over time, and there may be time series data that changes relatively rapidly (high frequency). Additionally, there may be time series data that repeats a specific pattern.

Due to the development of deep learning technology, it is possible to analyze and predict not only static data, but also time series data and non-time series data. Time series data may have limitations in that a large amount of learning data is required to obtain reliable analysis and prediction results through deep learning. In reality, it may be difficult to obtain a lot of data or may take a long time. Suitable deep learning algorithms may be different, according to respective time series data.

When time series data is input into an inappropriate deep learning algorithm, it may be difficult to obtain the desired results. There may be a problem that appropriate deep learning algorithms are different, depending on the characteristics of time series data, and learning data is often insufficient. Even when there is little learning data, an integrated deep learning model that may output highly reliable results, regardless of the characteristics of the time series data, may be required.

A learning model learned using deep learning according to an embodiment of the present disclosure may perform prior learning using various training time series data (or learning time series data). In addition to time series data, non-time series data may also be trained.

The learning model may include a plurality of deep learning algorithms, and an appropriate deep learning algorithm may be applied regardless of a type of time series data or a type of non-time series data.

In a learning model according to an embodiment of the present disclosure, a state of learning data may be determined and a labeling operation may be performed for preprocessing of the learning data.

For example, in a road surface severity estimation model to be described below, the labeling operation may be an operation of identifying deep/shallow road surfaces required for learning.

An artificial intelligence learning model or a neural network model may be designed to implement a human brain structure in the computer. The artificial intelligence learning model or neural network model may include a plurality of network nodes simulating neurons of a human neural network and having weights. The plurality of network nodes may have a connection relationship with each other by simulating synaptic activity of the neurons in which the neurons exchange signals through synapses. In the artificial intelligence learning model, the plurality of network nodes may be located in layers of different depths, and may exchange data according to a convolutional connection relationship.

The artificial intelligence learning model may be, for example, an artificial neural network model, a convolution neural network (CNN) model, or the like. As an example, the artificial intelligence learning model may be machine-learned according to a method such as supervised learning, unsupervised learning, reinforcement learning, or the like. As a machine learning algorithms for performing machine learning, a decision tree, a Bayesian network, a support vector machine, an artificial neural network, Adaboost, perceptron, genetic programming, clustering, or the like may be used.

The road surface severity estimator 210 may estimate road surface severity with a score within a preset range using the road surface severity estimation model. For example, the road surface severity estimator 210 may estimate road surface severity with a score ranging from 0 to 1, based on travel data.

In this case, the road surface severity estimator 210 may estimate a score closer to 0 for shallow road surfaces having stuck low occurrence probability. Alternatively, the road surface severity estimator 210 may estimate a score closer to 1 for deep road surfaces having a high stuck occurrence probability.

The road surface severity estimator 210 may estimate the road surface severity based on the estimated score. The road surface severity estimator 210 may estimate the road surface as a deep road surface when the estimated score is greater than a preset score, and may estimate the road surface as a shallow road surface when the estimated score is lower than the preset score.

The road surface severity estimation model may include a deep learning network learned based on a type of road surface. The road surface severity estimation model may include a plurality of deep learning networks, and each of the deep learning networks may be learned based on the type of road surface.

For example, the road surface severity estimation model may include a first deep learning network and a second deep learning network.

The first deep learning network may perform deep learning, based on data acquired from a sandy road surface, to determine the sandy road surface as a deep road surface or a shallow road surface. In addition, the second deep learning network may perform deep learning, based on data acquired from a muddy road surface, to determine the muddy road surface as a deep road surface or a shallow road surface.

Additionally, the road surface severity estimator 210 may estimate road surface severity by selecting a deep learning network included in the road surface severity estimation model according to a type of road surface input through the receiver 100.

In this case, each of the deep learning network may include a convolution neural network (CNN) having a 1D convolution layer, and a long-shot term memory (LSTM) network.

For example, the road surface severity estimation model may include two deep learning networks. Among the two deep learning networks, one deep learning network may estimate sandy road surface severity, and the other deep learning network may estimate muddy road surface severity. A deep learning network for estimating the sandy road surface severity and a deep learning network for estimating the muddy road surface severity may include a convolution neural network (CNN) having a 1D convolution layer, and a long-shot term memory (LSTM) network, respectively, and may be trained individually.

The road surface severity estimator 210 may estimate road surface severity without using a deep-learned road surface severity estimation model. For example, the road surface severity estimator 210 may directly sense a ground state (e.g., the presence or absence of a puddle, a curvature state of a road surface, a depth of a wheel submerged in the road surface, or the like) using a sensor such as a photo sensor, an infrared sensor, a Lidar, or the like, to estimate road surface severity.

The estimator 200 may further include the traveling speed estimator 220. The estimator 200 may estimate an off-road traveling speed, based on travel data of the vehicle received from the receiver 100, using the traveling speed estimator 220.

In this specification, the off-road traveling speed may mean a vehicle speed estimated based on the travel data of the vehicle received from the receiver, and the vehicle speed may be a concept including the vehicle speed received from the receiver and the off-road traveling speed.

The traveling speed estimator 220 may estimate a wheel slip rate of each wheel using the deep-learned wheel slip estimation model. The traveling speed estimator 220 may estimate the off-road traveling speed based on the estimated wheel slip rate.

The wheel slip estimation model may estimate a wheel slip rate and a variance value of each wheel by encoding input data using LSTM and decoding the same through a linear layer.

In this case, the wheel slip estimation model may prevent data in the wheel from being lost by using skip connection. More specifically, the wheel slip estimation model may prevent data in the wheel from being lost by combining the encoded signal using the LSTM and a signal in the wheel before the encoding.

Additionally, the LSTM used for encoding may include three layers. The linear layer used for the decoding may include four layers, and may further include an activation function between each of the linear layers.

In this case, the activation function may add non-linearity to output data, and the activation function according to an embodiment of the present disclosure may be leaky ReLU (Rectified Linear Unit). In this case, the LSTM, the skip connection, the linear layer, and the activation function may be known technologies.

The wheel slip estimation model may be trained using a wheel slip rate calculated using a global positioning system (GPS) as a true value.

The traveling speed estimator 220 may estimate the off-road traveling speed based on the wheel slip rate estimated using the wheel slip estimation model described above. The traveling speed estimator 220 may estimate the off-road traveling speed by dividing the estimated wheel slip rate into a case in which the estimated wheel slip rate is less than a preset value (e.g., the wheel slip rate is 0) and a case in which the estimated wheel slip rate is equal to or greater than the preset value.

For example, the traveling speed estimator 220 according to an embodiment of the present disclosure may estimate the off-road traveling speed using Equation 1 when the wheel slip rate is less than a set value (e.g., 0). Additionally, the traveling speed estimator 220 may estimate the off-road traveling speed using Equation 2 when the wheel slip rate is equal to or greater than the set value (e.g., 0).

$$V = \frac{R ω}{λ + 1} \qquad [ Equation 1 ]$$

$$V = ( 1 - λ ) R ω \qquad [ Equation 2 ]$$

where, V is an off-road traveling speed, R is a diameter of a tire, λ is a wheel slip rate, and ω is a rotational angular speed of a wheel.

The traveling speed estimator 220 may estimate the off-road traveling speed using a wheel slip estimation model that is deep-learned using GPS values, thereby more accurately estimating a vehicle speed even on an off-road surface in which a large amount of wheel slip occurs.

Additionally, probability may be determined using the more accurate off-road traveling speed, thereby the reliability of determining the stuck probability of the vehicle may be improved.

The off-road traveling speed is not limited to the estimation using the traveling speed estimator 220, but a speed estimated using the vehicle speed or travel data received from the receiver 100 using a speed sensor or the like provided in the vehicle, or the like may be applied.

The storage unit 400 may store a road surface severity estimation model and a wheel slip estimation model, including a trained deep learning network. Additionally, the storage unit 400 may store travel data received through the receiver 100 and data estimated by the estimator 200.

For example, the storage unit 400 may store data regarding the accelerator open value received through the receiver 100. The storage unit 400 may store data regarding the road surface severity estimated by the road surface severity estimator 210.

The storage unit 400 may be a recording medium suitable for storing the road surface severity estimation model, the wheel slip estimation model, and the travel data. The storage unit 400 may include: a magnetic media such as a hard disk, a floppy disk, or a magnetic tape; an optical media such as a compact disk read-only memory (CD-ROM) or a digital video disk (DVD); a magneto-optical media such as a floptical disk; or a semiconductor memory such as a flash memory, an erasable programmable ROM (EPROM), or an SSD manufactured based thereon.

The start condition determiner 300 may determine the stuck probability of the vehicle, based on travel data received by the receiver 100 or data estimated by the estimator 200, when deciding to determine the stuck probability. The stuck probability determiner 500 may determine the stuck probability by quantifying the same.

The stuck probability determiner 500 may determine the stuck probability of a vehicle, which is traveling, using the accelerator open value of the vehicle, the speed of the vehicle, the wheel slip rate of the vehicle, and data regarding the road surface severity.

In this case, data regarding the accelerator open value of the vehicle, which is traveling, data regarding the speed of the vehicle, data regarding the wheel slip rate of the vehicle, and data regarding the road surface severity may be received from the receiver 100 or the estimator 200.

The stuck probability determiner 500 may determine the stuck probability of the vehicle using a meta-model. The meta-model may be preset and stored, and may be updated periodically or continuously based on real-time traveling data.

The meta-model may be defined as a function including a plurality of parameters. The plurality of parameters constituting the meta-model may include individual functions, respectively. The meta-model may include the plurality of parameters in a multiplication form or an addition form.

In this case, a meta-model including the multiplication form may be referred to as a first meta-model, and a meta-model including the addition form may be referred to as a second meta-model.

Additionally, the plurality of parameters may include a function determined according to an input value, respectively. In this case, the input value for determining the plurality of parameters may include at least one value of the wheel slip rate of the vehicle, the accelerator open value of the vehicle, the speed of the vehicle, or the road surface severity.

In more detail, the stuck probability determiner 500 may determine stuck probability using the meta-model, and a first meta-model according to an embodiment of the present disclosure may be calculated and determined, for example, by Equation 3 below:

$${S}_{t o t a l 1} = min ( 1 , {S}_{s l i p 1} * {S}_{A P S 1} * {S}_{vel 1} * {S}_{D / S , 1} ) \qquad [ Equation 3 ]$$

where, Sₜₒₜₐₗ₁ is stuck probability estimated in a first meta-model, Sₛₗᵢₚ₁ is a parameter determined based on slip, S_{APS1} is a parameter determined based on the accelerator open value of a vehicle, Sᵥₑₗ₁ is a parameter calculated based on a speed of the vehicle, and S_{D/S,1} is a parameter determined based on road surface severity.

Sₛₗᵢₚ₁, S_{APS1}, Sᵥₑₗ₁, and S_{D/S,1}, constituting the first meta-model, may be calculated and determined according to a function including a variable, respectively. Additionally, Sₛₗᵢₚ₁, S_{APS1}, Sᵥₑₗ₁, and S_{D/S,1} may be determined, for example, by Equations 4 to 7 below, respectively:

$${S}_{s l i p 1} = - exp ( - 4.5 * λ ) + 1 \qquad [ Equation 4 ]$$

According to Equation 4, A is a wheel slip rate, wherein the wheel slip rate may use a value measured through a receiver 100, or may use a value estimated from a deep-learned wheel slip estimation model of a traveling speed estimator 220.

$${S}_{APS 1} = ( 0.282 * exp ( - 0.158 * a p s ) + 0.218 * exp ( 0.0152 * aps ) \qquad [ Equation 5 ]$$

where, aps is an accelerator open value.

$${S}_{vel 1} = max {( 1 , V )}^{- 1 / 3} \qquad [ Equation 6 ]$$

where, V is a speed of a vehicle, wherein the speed of the vehicle may use a vehicle speed value measured through a receiver 100, may use an off-road traveling speed value estimated by a traveling speed estimator 220, or may use a vehicle speed value measured using GPS.

$${S}_{D / S 1} = 0.7 + 0.5 * W \qquad [ Equation 7 ]$$

where, W is a score value related to road surface severity received from a road surface severity estimator 210 of an estimator 200.

Additionally, the second meta-model based on the addition form may calculate stuck probability, for example, based on Equation 8 below. In this case, the second meta-model may determine the stuck probability using different formulas depending on a type of road surface.

For example, the second meta-model may determine stuck probability in different manners depending on a type of road surface by changing and applying a constant value applied to a parameter depending on the type of road surface.

$${S}_{total 2 - 1} = max ( 0 , min ( 1 , {w}_{1} {S}_{s l i p 2} * {S}_{A P S 2} + {w}_{2} {S}_{D / S , 2} - {w}_{3} {S}_{vel 2} ) ) \qquad [ Equation 8 ]$$

In the muddy road surface, w₁=0.7, w₂=0.6, w₃=0.3 may be satisfied, and in the sandy road surface, w₁=0.9, w₂=0.4, w₃=0.3 may be satisfied. In this case, w₁, w₂, w₃ may be values determined by an experiment, and may be constants that may be adjusted depending on a type of vehicle used in a test, a type of tire applied, or the like.

Additionally, in a case in which the vehicle is automatically controlled in a stuck mode or the like, rather than by a driver, the second meta-model may calculate the stuck probability using an equation illustrated in Equation 9.

When a vehicle is automatically controlled, unlike when a user controls the vehicle, an accelerator open value may not exist. Therefore, the stuck probability may be calculated without data on the accelerator open value. In this case, the stuck mode may be an optimal automatic traveling mode set according to a type of road surface on which the vehicle is traveling, a road surface severity, or the like.

$${S}_{total 2 - 2} = max ( 0 , min ( 1 , {w}_{1} {S}_{s l i p 2} + {w}_{2} {S}_{D / S , 2} - {w}_{3} {S}_{vel 2} ) ) \qquad [ Equation 9 ]$$

In the muddy road surface, w₁=0.7, w₂=0.72, w₃=0.3 may be satisfied, and in the sandy road surface, w₁=1.3, w₂=0.5, w₃=0.2 may be satisfied. In this case, w₁, w₂, w₃ may be values determined by an experiment, and may be constants that may be adjusted depending on a type of vehicle used in a test, a type of tire applied, or the like.

Sₛₗᵢₚ₂, S_{APS2}, Sᵥₑₗ₂, and S_{D/S,2}, constituting the second meta-model, may be calculated and determined according to a function including a variable, respectively. Additionally, Sₛₗᵢₚ₂, S_{APS2}, Sᵥₑₗ₂, and S_{D/S,2} may be calculated as illustrated in Equations 10 to 13 below, respectively:

$${S}_{s l i p 2} = - exp ( - 4.5 * λ ) + 1 \qquad [ Equation 10 ]$$

where, λ is a wheel slip rate, wherein the wheel slip rate may use a value measured through a receiver 100, or may use a value estimated from a deep-learned wheel slip estimation model of a traveling speed estimator 220.

$$\begin{matrix}APS \geq 15 , \\ {S}_{A P S 2 - 1} = ( 0.2874 * exp ( - 0.1591 * a p s ) + 0.4153 * exp ( 0.0088 * aps ) ) \\ APS < 15 , \\ {S}_{A P S 2 - 2} = \frac{0.2}{15} * a p s + 0.3\end{matrix} \qquad [ Equation 11 ]$$

where, aps is an accelerator open value. S_{APS2} may be determined by using the accelerator open value in a different manner. For example, S_{APS2} may be determined by dividing the accelerator open value into a case in which the accelerator open value is equal to or greater than a preset value and a case in which the accelerator open value is less than the preset value, based on the preset value (e.g., 15).

$${S}_{vel 2} = max ( 0 , min ( 1 , sign ( V - 5 ) * {( \frac{1}{15} * ( V - 5 ) )}^{2} ) ) \qquad [ Equation 12 ]$$

where, V is a speed of a vehicle, wherein the speed of the vehicle may use a vehicle speed value measured through a receiver 100, may use an off-road traveling speed value estimated by a traveling speed estimator 220, or may use a vehicle speed value measured using GPS.

$${S}_{D / S , 2} = W \qquad [ Equation 13 ]$$

where, W is a score value related to road surface severity received from a road surface severity estimator 210 of an estimator 200.

The function for each parameter may mean a function for stuck occurrence risk corresponding to the variable included in each function. For example, Sₛₗᵢₚ may be a function for stuck occurrence risk due to the change in wheel slip rate.

The function for each parameter may be derived by analyzing data acquired through actual traveling.

To derive a value for stuck occurrence risk, a stuck risk rate illustrated as an example in Equation 14 below may be calculated:

$$high stuck ratio = \frac{num Deep Label}{num Deep Label + num Shallow Label} \qquad [ Equation 14 ]$$

In this case, the stuck risk rate may be calculated based on road surface severity data received from the estimator 200 (more specifically, the road surface severity estimator 210). Additionally, the road surface severity estimator 210 may be calculated based on region data estimated from deep and shallow road surfaces. In this case, the deep road surface may be a road surface having high stuck occurrence probability, and the shallow road surface may be a road surface having low stuck occurrence probability.

In addition, an expert may label deep and shallow road surface sections by actually traveling and determining stuck probability of the road surface. The expert may also use the learned road surface estimation model to receive data regarding the deep and shallow road surface sections.

The stuck risk rate may be determined as a ratio of the number estimated as a deep road surface relative to a sum of the number estimated as a deep road surface and the number estimated as a shallow road surface in a corresponding section or a corresponding parameter.

To derive the function for each parameter, the road surface severity data in traveling the vehicle, may be acquired, in addition to the wheel slip rate of the vehicle, the accelerator open value of the vehicle, and data regarding the speed of the vehicle.

Data regarding the estimated stuck risk rate may be obtained based on the wheel slip rate of the vehicle, the accelerator open value of the vehicle, the speed of the vehicle, and the road surface severity. Additionally, the relationship between the wheel slip rate of the vehicle, the accelerator open value of the vehicle, the speed of the vehicle, and the stuck risk rate may be approximated with a simple function.

In this case, the functional relationship between the wheel slip rate of the vehicle, the accelerator open value of the vehicle, the speed of the vehicle, and the stuck risk rate may be estimated probabilistically using regression analysis, and may be estimated using a best-fit line, a trend line, and curve fitting using interpolation or approximation.

In addition, the functional relationship between the wheel slip rate of the vehicle, the accelerator open value of the vehicle, the speed of the vehicle, and the stuck risk rate may be estimated using various known methods such as approximation by linear combination of exponential functions, Laplace approximation, least squares approximation, or the like.

The stuck probability estimation device may include the post-processor 600. The post-processor 600 may post-process a result determined by the stuck probability determiner 500. The post-processor 600 may apply various post-processing depending on a type of meta-model used in the stuck probability determiner 500.

The post-processor 600 may determine stuck probability using the number of windows for which a stuck probability score exceeding a preset score is calculated during a preset time. In this case, a post-processing method of determining the stuck probability using the number of windows may be referred to as a first post-processing method. More specifically, the post-processor 600 may

generate a window storing a score calculated by the stuck probability determiner 500. For example, the post-processor 600 may generate twenty windows at 50 millisecond (ms) intervals. Scores may be stored in the generated window.

In this case, 1 or 0 may be stored in the generated window. When a score calculated in the stuck probability determiner 500 (e.g., 0.3) is greater than a preset score (e.g., 0.15), 1 may be stored in a window corresponding thereto. Furthermore, when a score calculated in the stuck probability determiner 500 (e.g., 0.1) is less than the preset score (e.g., 0.15), 0 may be stored in a window corresponding thereto.

In this case, the stuck probability may be expressed in numbers as a ratio of the number of windows exceeding a preset score relative to a preset window size.

For example, when the number of windows in which 1 is stored, among the twenty windows, is 15, the stuck probability may be displayed as 75 percent.

In this case, data input to the window may have a first in first out (FIFO) structure. FIFO may be a structure in which data are sequentially output in sequence in which they are input, for example, in which a value input earlier is output earlier.

In the first post-processing method, it may be applied to a stuck probability score determined using a first meta-model. In particular, in the first meta-model that determines the stuck probability score as a value between 0 and 1, although the stuck probability score changes depending on a parameter, it may be generally very rare to generate a value close to 1. In this case, using the first post-processing method, it may be more easily determined as a value between 0 and 1.

The post-processor 600 may use an exponential moving average (EMA). In this case, a post-processing method using an exponential moving average may be referred to as a second post-processing method. In this case, the exponential moving average (EMA) may be a moving average that gives a greater weight and a greater significance to a latest data point.

The post-processor 600 may use the exponential moving average, to prevent noise in a stuck probability score calculated by a stuck probability calculator, and may reflect a past value to derive a more accurate stuck probability.

In applying the exponential moving average, the post-processor 600 may perform post-processing by applying at least two exponential constants (exponential parameters) based on the stuck probability score calculated by the stuck probability determiner 500.

In this case, as a size of an exponential constant decreases, the exponential moving average may increase a proportion of past data to perform more stable and accurate estimation. As the proportion of the past data increases, an immediate response to current data is not possible and delay time may occur.

The second post-processing method may reduce noise in a stuck probability score determined when applied to a second meta-model, and may determine stuck probability more accurately.

The off-road travel assistive device may include the stuck mode determiner 700.

The stuck mode determiner 700 may determine a stuck mode using a calculated stuck probability score or a post-processed stuck probability score. The stuck mode determiner 700 may apply hysteresis when determining the stuck mode.

More specifically, the stuck mode determiner 700 may generate an on/off signal of the stuck mode by applying the hysteresis based on the calculated stuck probability score or the post-processed stuck probability score.

In this case, the stuck mode may be an optimal automatic traveling mode set to control traveling of a vehicle such that the vehicle does not get stuck depending on a type of road surface on which the vehicle is traveling, road surface severity, or the like.

The stuck mode determiner 700 may quickly turn on a stuck mode when stuck probability is measured to be higher than a preset score in a process of traveling with the stuck mode turned off.

Additionally, the stuck mode determiner 700 may turn off a stuck mode when stuck probability is measured to be lower than a preset score in a process of traveling with the stuck mode turned on.

In this case, a preset score that serves as a standard for changing a stuck mode from a turned off state to a turned on state may be different from a preset score that serves as a standard for changing a stuck mode from a turned on state to a turned off state.

In particular, the preset score that serves as a standard for changing a stuck mode from a turned off state to a turned on state may be greater than the preset score that serves as a standard for changing a stuck mode from a turned on state to a turned off state.

When a stuck probability score changes within a range close to a score that is a standard for changing a stuck mode and repeatedly increases and decreases than the score that is the standard for changing the stuck mode, the stuck mode determiner 700 may use hysteresis to frequently change the stuck mode, to solve problems of driver confusion.

For example, by using hysteresis, the stuck mode determiner 700 may prevent a stuck mode from turning on/off frequently and stably maintain the stuck mode.

The stuck mode determiner 700 may set a stuck stage based on the stuck probability score determined by the stuck probability determiner 500, and may then determine a stuck mode based on each stuck stage.

For example, the stuck mode determiner 700 may set a case in which a stuck probability score is greater than 0 and less than 0.3 as a 0th stuck stage, may set a case in which a stuck probability score is greater than 0.3 and less than 0.6 as a first stuck stage, and may set a case in which a stuck probability score is greater than 0.6 and less than 1 as a second stuck stage.

For example, the 0th stuck stage may be a stage in which stuck occurrence probability is very low, and a vehicle continues to travel while determining a stuck probability score by the stuck mode determiner 700 without taking any special action.

The first stuck stage may be a stage in which stuck occurrence probability is slightly high, and a driver is alerted with an attention through the notification unit 900, which is described below. The stuck mode determiner 700 may determine a first stuck mode in the first stuck stage. In the first stuck mode, the driver's attention may be alerted using the notification unit 900.

For example, in the first stuck stage, the stuck mode determiner 700 may display a guidance phrase or may provide voice guidance such as “please be especially careful as you are currently traveling on a road with high stuck occurrence probability” to the driver through the notification unit 900.

The second stuck stage may be a stage in which stuck occurrence probability is very high. When a vehicle is stuck, it may be very difficult to get out of the stuck state. Therefore, the stuck mode determiner 700 may determine a second stuck mode in the second stuck stage, and the second stuck mode may exclude the driver's traveling control to prevent the vehicle from being stuck, and may allow traveling in a preset autonomous traveling mode in preparation for stuck occurrence.

For example, when the second stuck mode is determined, the stuck mode determiner 700 may transmit a second stuck mode signal to a main controller using the transmitter 800, and the vehicle may travel autonomously by the main controller according to a preset off-road control mode. Additionally, even when the second stuck mode is executed, the stuck mode determiner 700 may notify the driver that the second stuck mode has started by the notification unit 900.

In this case, the main controller may control the vehicle to accelerate, decelerate, or stop using an acceleration control device or a braking force control device in the vehicle. Additionally, the main controller may be connected to a steering device in the vehicle to control a traveling direction of the vehicle. The main controller may assist the vehicle in traveling autonomously according to a preset program without the need for driver intervention.

A stuck mode according to an embodiment of the present disclosure may include a total of three stages, but is not limited thereto. For example, the stuck mode may include two or four or more stages, and various stuck modes may be applied accordingly.

The off-road travel assistive device may further include the transmitter 800. The transmitter 800 may transmit the stuck mode determined by the stuck probability determiner 500 to the main controller through wired or wireless communications. The transmitter 800 may transmit data through an ethernet, a media oriented systems transport (MOST), a flexray, a controller area network (CAN), a local interconnect network (LIN), or the like.

Additionally, the transmitter 800 may include a radio frequency (RF) antenna. The transmitter 800 may be compatible with an existing vehicle control system by applying the RF antenna, but is not limited thereto, and may apply various wired or wireless communication systems that may be compatible with an existing system.

The off-road travel assistive device may further include the notification unit 900. The notification unit 900 may notify the driver of a stuck probability score determined by the stuck probability determiner 500.

The notification unit 900 may notify the driver of a stuck probability score determined by the stuck probability determiner 500 or a stuck mode determined by the stuck mode determiner 700. The notification unit 900 may visually or audibly notify the driver of the stuck probability score or the stuck mode.

For example, the stuck probability score may be displayed on a cluster including a display of the vehicle, and the cluster may inform the driver of the stuck probability score. Additionally, using an audio of the vehicle (e.g., “stuck mode has been started,” or the like), the switching of the stuck mode of the vehicle may be announced.

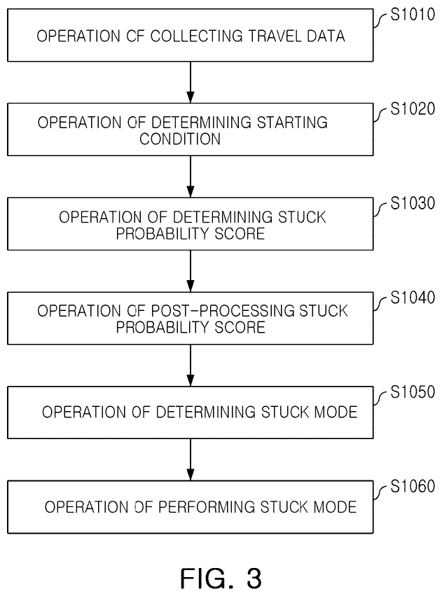

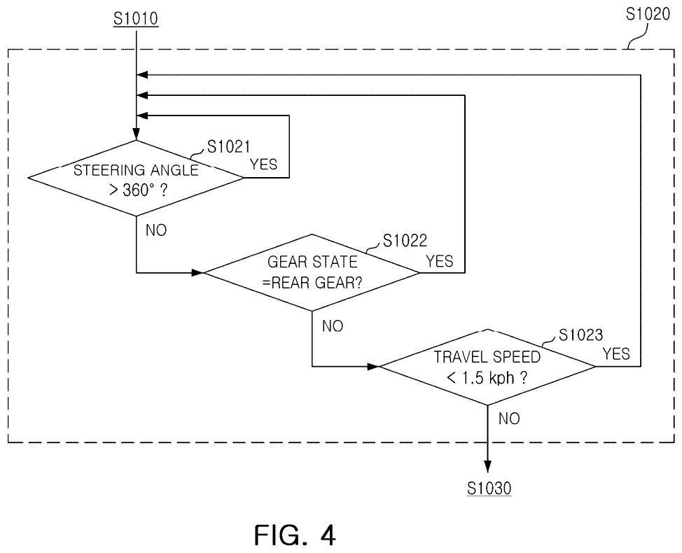

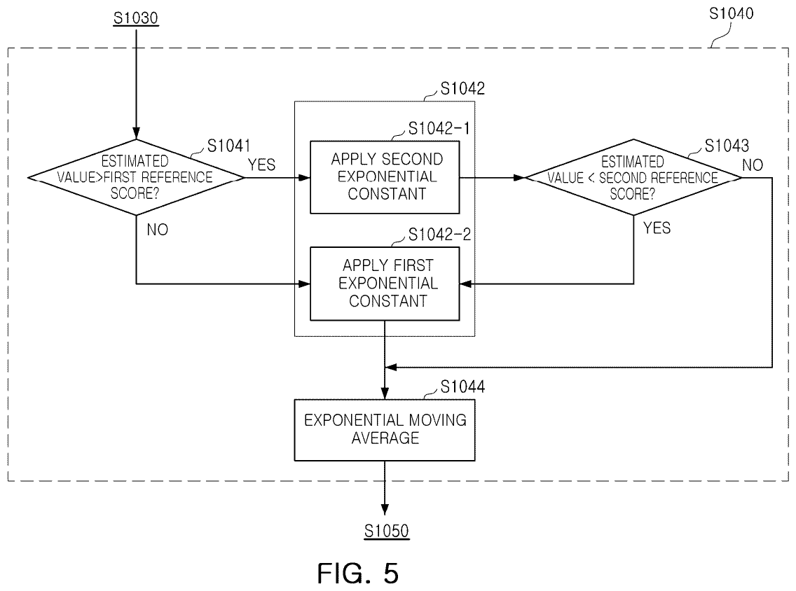

FIG. 3 is a flowchart of a method for estimating stuck probability according to an embodiment of the present disclosure. FIG. 4 is a detailed flowchart of S1020 of FIG. 3 according to an embodiment of the present disclosure. FIG. 5 is a flowchart illustrating a process of applying an exponential moving average of a post-processor 600 according to an embodiment of the present disclosure.

Referring to FIG. 3, a method for estimating stuck probability according to an embodiment of the present disclosure may include: an operation of collecting travel data of a vehicle (S1010); an operation of determining a starting condition for determining stuck probability (S1020); an operation of determining a stuck probability score (S1030); an operation of post-processing the stuck probability score (S1040); an operation of determining a stuck mode (S1050); and an operation of performing the stuck mode (S1060).

In a method for estimating stuck probability according to an embodiment of the present disclosure, an operation of collecting travel data (S1010) may receive travel data of a vehicle through a receiver 100. Additionally, the operation of collecting travel data may receive estimated data through an estimator 200. In this case, the travel data may include data such as a wheel slip rate of the vehicle, an accelerator open value of the vehicle, a speed of the vehicle, road surface severity, a steering angle of the vehicle, a currently traveling gear ratio of the vehicle, or the like.

In this case, the speed of the vehicle may be measured through the receiver 100, or may be an off-road traveling speed estimated by a traveling speed estimator 220.

In this case, the estimator 200 may include a road surface severity estimator 210 that estimates road surface severity. The estimator 200 may also include a traveling speed estimator 220 that estimates the off-road traveling speed of the vehicle.

The traveling speed estimator 220 may estimate the wheel slip rate using a deep-learned wheel slip estimation model, and may also estimate the off-road traveling speed using the estimated wheel slip rate.

The road surface severity estimator 210 may estimate the road surface severity using a deep-learned road surface severity estimation model.

A method for estimating stuck probability according to an embodiment of the present disclosure may determine a starting condition for determining stuck probability using the collected travel data (S1020). In certain situations, it may be very difficult to determine the stuck probability. Furthermore, it may be very difficult to determine the stuck probability even when the stuck probability is determined, because the accuracy thereof may be very low. Additionally, since the likelihood of encountering the stuck probability is low, determining the stuck probability may be meaningless.

For example, the operation of determining a starting condition for determining stuck probability may determine whether or not to start the determination of a stuck probability determiner 500, based on a traveling state of the vehicle. Thereby, it is possible to avoid determining the stuck probability, when the stuck probability of the vehicle is very low or the vehicle is in a traveling state in which it is difficult to accurately determine the stuck probability. Examples of traveling conditions in which it is difficult to accurately determine the stuck probability may include a case in which a vehicle makes a sharp turn, a case in which a vehicle is reversing, or a case in which a vehicle is close to a stopped state.

Referring to FIG. 4, a method for estimating stuck probability according to an embodiment of the present disclosure may not determine the stuck probability when a steering angle exceeds an angle setting value (e.g., 360 degrees) (S1021).

A method d for estimating stuck probability according to an embodiment of the present disclosure may determine a gear state when a steering angle does not exceed an angle setting value (e.g., 360 degrees), and may not determine the stuck probability when the gear state is in reverse gear (S1022).

A method for estimating stuck probability according to an embodiment of the present disclosure may determine whether a speed of a vehicle is less than a speed set value (e.g., 1.5 kph), when the gear state is not in reverse gear, and may not determine the stuck probability when the speed of the vehicle is less than the speed set value (e.g., 1.5 kph) (S1023). A method for estimating stuck probability according to an embodiment of the present disclosure may determine the stuck probability, when a speed of a vehicle is equal to or greater than a speed set value (e.g., 1.5 kph).

For example, a method for estimating stuck probability according to an embodiment of the present disclosure may determine the stuck probability when a steering angle does not exceed an angle setting value (e.g., 360 degrees), a gear state is not in reverse gear, and a speed of a vehicle is equal to or greater than a speed set value (e.g., 1.5 kph). Additionally, a method for estimating stuck probability may not determine the stuck probability when at least one condition is not satisfied.

In this case, an order of operations S1021, S1022, and S1023 may be changed, and may be connected in parallel, rather than sequentially. The order of operations may also be determined simultaneously.

When stuck probability of a vehicle is determined, an operation of determining the stuck probability of the vehicle may be performed based on the travel data (S1030).

In this case, the stuck probability may be determined as a probability score using a meta-model including a plurality of parameters.

In this case, the meta-model may be defined as a function including the plurality of parameters. The plurality of parameters constituting the meta-model may include individual functions, respectively.

The meta-model may include the plurality of parameters in a multiplication form or an addition form. In this case, a meta-model including the multiplication form may be referred to as a first meta-model, and a meta-model including the addition form may be referred to as a second meta-model.

The meta-model may be preset and stored, and may be updated periodically or continuously based on real-time traveling data.

In the operation of determining the stuck probability, the stuck probability score may be determined using a meta-model, based on the travel data collected in operation S1010. A meta-model according to an embodiment of the present disclosure may include parameters including at least one value of the wheel slip rate of the vehicle, the accelerator open value of the vehicle, the speed of the vehicle, or the road surface severity.

A method for determining stuck probability according to an embodiment of the present disclosure may determine the stuck probability using a meta-model, such that a plurality of parameters may not be applied sequentially according to importance, but instead, the values determined by the plurality of parameters may be applied simultaneously to determine more accurately the stuck probability.

In particular, a method for estimating stuck probability according to an embodiment of the present disclosure may apply a meta-model, rather than a rule-based model, to determine more accurately the stuck probability, in comprehensive consideration of detecting changes in a plurality of parameters, regardless of an application order or priority of the plurality of parameters that determine the stuck probability.

After the stuck probability is determined, an operation of post-processing the determined stuck probability may be performed (S1040). In the operation of the stuck probability, various post-post-processing processing methods may be applied depending on a meta-model.

In the operation of post-processing the stuck probability, the stuck probability may be post-processed using the number of windows. In this case, a post-processing method of determining the stuck probability using the number of windows may be referred to as a first post-processing method.

More specifically, the first post-processing method may determine stuck probability using the number of windows in which a stuck probability score exceeding a preset score is calculated during a preset time.

For example, the first post-processing method may generate a window storing a score calculated by a stuck probability determiner 500 and having a predetermined length. For example, a post-processor 600 may generate twenty windows at 50 millisecond (ms) intervals. Scores may be stored in the generated window.

In this case, 1 or 0 may be stored in the generated window. When a score calculated in the stuck probability determiner 500 (e.g., 0.3) is greater than a preset score (e.g., 0.15), 1 may be stored in a window corresponding thereto. Additionally, when a score calculated in the stuck probability determiner 500 (e.g., 0.1) is less than the preset score (e.g., 0.15), 0 may be stored in a window corresponding thereto.

In this case, the stuck probability may be expressed in numbers as a ratio of the number of windows exceeding a preset score relative to a preset window size. For example, when the number of windows in which 1 is stored, among the twenty windows, is 15, the stuck probability may be displayed as 75 percent.

In this case, data input to the window may have a first in first out (FIFO) structure. FIFO may be a structure in which data are sequentially output in sequence in which they are input, for example, in which a value input earlier is output earlier.

In the first post-processing method, it may be applied to a stuck probability score determined using a first meta-model, but is not limited thereto.

In the operation of post-processing the stuck probability, post-processing may be done using an exponential moving average (EMA), and a post-processing method using an exponential moving average may be referred to as a second post-processing method.

In this case, the exponential moving average (EMA) may be a moving average that gives a greater weight and a greater significance to a latest data point. The post-processor 600 may use the exponential moving average, to prevent noise in a stuck probability score calculated by a stuck probability calculator, and may reflect a past value to derive a more accurate stuck probability.

Additionally, in the second post-processing method, post-process may be performed by applying an exponential constant (exponential parameter) applied to the exponential moving average differently depending on a size of the stuck probability. In this case, as a size of an exponential constant decreases, the exponential moving average may increase a proportion of past data to perform more stable and accurate estimation. As the proportion of the past data increases, immediate response to current data is not possible and delay time may occur. Therefore, it is possible to estimate more accurately by adjusting the size of the exponential constant depending on a situation.

To explain with reference to FIG. 5, a stuck probability score value received from a stuck probability determiner 500 may be compared with a preset first reference score (e.g., 0.5) (S1041). Additionally, exponential constants with different sizes may be applied depending on comparison results (S1042).

More specifically, when the stuck probability

score value is greater than the first reference score, a second exponential constant (e.g., 0.001) may be applied (S1042-1). Additionally, when the stuck probability score value is lower than the first reference score, a first exponential constant (e.g., 0.01) may be applied (S1042-2).

In this case, the first exponential constant (e.g., 0.01) may be greater than the second exponential constant (e.g., 0.001).

For example, when it is determined that the stuck probability is high through the second post-processing, by applying the second exponential constant, the stuck probability determiner 500 may be configured to more accurately determine the stuck probability by reflecting more past data.

Additionally, even when the second exponential constant is applied, the stuck probability score value received from the stuck probability determiner 500 may be compared with the second reference score (e.g., 0.1) (S1043).

In this case, when the stuck probability score value is greater than the second standard score, the second exponential constant may be maintained. Furthermore, when the stuck probability score value is lower than the second standard score, the first exponential constant may be applied (S1042).

Through this, in a case in which the stuck probability score value is lower than the second reference score, since a current traveling state may have a low stuck occurrence probability, a relatively large exponential constant value may be applied to reduce load on a system.

In the operation of post-processing the stuck probability, after the first exponential constant or the second exponential constant are determined, the stuck probability score value determined in the stuck probability determining stage may be post-processed using the exponential moving average using the determined exponential constant (S1044)).

After post-processing the stuck probability score, a stuck mode may be determined based on the post-processed stuck probability score, and the determined stuck mode may be performed (S1050 and S1060).

In the operation of determining the stuck mode, the stuck mode may be determined based on the stuck probability score value determined in the operation of determining the stuck probability or the stuck probability score value post-processed through the operation of post-processing.

The stuck mode may set a stuck operation according to a preset stuck standard, and the stuck mode may be determined according to the stuck operation.

For example, the stuck mode determiner 700 may set a case in which a stuck probability score is greater than 0 and less than 0.3 as a 0th stuck stage, and may set a case in which a stuck probability score is greater than 0.3 and less than 0.6 as a first stuck stage. The stuck mode determiner 700 may also set a case in which a stuck probability score is greater than 0.6 and less than 1 as a second stuck stage.

In this case, the 0th stuck stage may be a stage in which stuck occurrence probability is very low, and a vehicle continues to travel while determining a stuck probability score without taking any special action.

The first stuck stage may be a stage in which stuck occurrence probability is slightly high, and a driver is alerted with an attention by notifying the driver of stuck risk.

The second stuck stage may be a stage in which stuck occurrence probability is very high. When a vehicle is stuck, it is not possible to get out of a stuck state just by controlling the vehicle, and it is not possible to get out of the stuck state without external force such as a tow truck or the like. Therefore, in the second stuck stage, control of the vehicle may be transferred from the driver, and the vehicle may travel autonomously according to a preset control to prevent the vehicle from becoming stuck.

In the operation of determining the stuck mode, when traveling in a state classified as a first stuck mode, the first stuck mode may be determined. In an operation of performing the first stuck mode, the driver's attention may be alerted using a notification unit 900 provided in the vehicle.

For example, through the notification unit 900, a guidance phrase such as “please be especially careful as you are currently traveling on a road with a high stuck occurrence probability,” “you are currently entering a road surface with a high stuck risk. Please travel safely,” “Caution: You are currently traveling on a road on which it is highly probable that you will be stuck,” or “Caution: You are currently entering a road having a high risk for your vehicle becoming stuck. Please travel safely.”) or the like may be displayed using a display mounted on the vehicle. Alternatively, voice guidance may be provided using an audio device installed in the vehicle, to draw the driver's attention.

In the operation of determining the stuck mode, when the vehicle travels in a state classified as a second stuck mode, the second stuck mode may be determined. In the stage of performing the second stuck mode, the second stuck mode may exclude the driver's traveling control to prevent the vehicle from being stuck, and may allow traveling in a preset autonomous traveling mode in preparation for the occurrence of the vehicle becoming stuck.

For example, in the second stuck mode, a second stuck mode signal may be transmitted to a main controller using the transmitter 800. The main controller that receives the second stuck mode signal may travel autonomously according to a preset off-road control mode.

In this case, the main controller may control the vehicle to accelerate, decelerate, or stop using an acceleration control device or a braking force control device in the vehicle. Additionally, the main controller may be connected to a steering device in the vehicle to control a traveling direction of the vehicle. The main controller may assist the vehicle in traveling autonomously according to a preset program without driver intervention. A method of controlling the vehicle in the second stuck mode is not limited to using the main controller of the vehicle, and may be implemented by configuring an autonomous traveling controller for traveling in the second stuck mode.

Additionally, when the second stuck mode may be executed, the notification unit 900 may be used to notify the driver that the second stuck mode has started. For example, a cluster including a display of the vehicle, and an audio of the vehicle (e.g., “stuck mode has been started,” or the like) may be used to indicate that the vehicle has switched to autonomous traveling, reducing driver confusion.

As another embodiment, when performing the second stuck mode, the driver may be guided to transition to the second stuck mode. The driver's consent or confirmation may be required to travel in the autonomous traveling mode on behalf of the driver. In this case, the notification unit 900 may be used to inform the driver of phrases such as “the probability of becoming stuck is very high. Do you want to travel autonomously in the stuck mode?”. Furthermore, a separate display that is actuated, a switch button provided in the vehicle, or the like may be used to confirm the driver's intention, and autonomous traveling may be performed in the second stuck mode according to the confirmed intention.

In the operation of determining the stuck mode, the stuck mode may be determined using hysteresis. For example, when the stuck probability is measured to be higher than a preset score while traveling with the stuck mode turned off, the stuck mode may be quickly turned on.

Additionally, in the operation of determining the stuck mode, when the stuck probability is measured to be lower than a preset score while traveling with the stuck mode turned on, the stuck mode may be turned off.

In this case, a preset score that serves as a standard for changing a stuck mode from a turned off state to a turned on state may be different from a preset score that serves as a standard for changing a stuck mode from a turned on state to a turned off state.

In particular, the preset score that serves as a standard for changing a stuck mode from a turned off state to a turned on state may be greater than the preset score that serves as a standard for changing a stuck mode from a turned on state to a turned off state.

Through this, when a stuck probability score changes within a range close to a score that is a standard for changing a stuck mode and repeatedly increases and decreases than the score that is the standard for changing the stuck mode, the stuck mode may be frequently changed to solve any problems of driver confusion.

For example, a method of estimating stuck probability according to an embodiment of the present disclosure may use hysteresis in the operation of determining the stuck mode to prevent the stuck mode from turning on/off frequently and stably maintaining the stuck mode.

Methods of estimating stuck probability according to the present disclosure may be implemented to form program instructions that may be executed through various computer means, and may be recorded on a computer-readable media. The computer-readable media may include a program instruction, a data file, a data structure, or the like, singly or in combination. The program instruction recorded on the computer-readable media may be specially designed and constructed for the present disclosure, or may be known and usable by those having ordinary skill in the art.

Examples of computer-readable media may include a hardware device specially configured to store and execute a program instruction, such as a read-only memory (ROM), a random access memory (RAM), a flash memory, or the like. Examples of the program instruction may include a machine language code, such as that produced by a compiler, as well as a high-level language code that may be executed by a computer using an interpreter, or the like. The above-described hardware device may be configured to operate with at least one software module to perform the operations of the present disclosure, and vice-versa.

According to an embodiment of the present disclosure, stuck probability using a meta-model may be determined to accurately estimate the stuck probability by comprehensively considering travel data.

According to an embodiment of the present disclosure, when a driver travels a vehicle on a road surface that stuck probability is high, a device may inform the driver of the stuck probability of the driver, to alert the driver to travel with caution or to operate the vehicle more stably on an off-road.

According to an embodiment of the present disclosure, off-road traveling control of a vehicle traveling on a road surface having a high risk of being stuck may be started, based on stuck probability of the vehicle, to assist the vehicle to travel on an off-road more stably.

While example embodiments have been illustrated and described above, it should be apparent to those having ordinary skill in the art that modifications and variations could be made without departing from the scope of the present disclosure as defined by the appended claims.

What is claimed is:

1. An off-road travel assistive device comprising:
a receiver configured to receive travel data of a vehicle;
a road surface severity estimator configured to estimate road surface severity data based on the travel data of the vehicle; and
a stuck probability determiner configured to determine a probability of a stuck state of the vehicle occurring by using the travel data and the road surface severity data.

2. The off-road travel assistive device of claim 1, wherein the travel data comprises at least one of an accelerator open value of the vehicle, a wheel slip rate of the vehicle, a steering angle of the vehicle, a currently traveling gear ratio of the vehicle, a speed of the vehicle, or a type of road surface.

3. The off-road travel assistive device of claim 1, wherein the road surface severity estimator estimates road surface severity using a deep-learned road surface severity estimation model,
wherein the road surface severity estimation model estimates a road surface having stuck probability that is higher than a preset standard, as a deep road surface, and estimates a road surface having stuck probability that is lower than the preset standard, as a shallow road surface.

4. The off-road travel assistive device of claim 3, wherein the road surface severity estimation model estimates the road surface severity as a score having a predetermined range.

5. The off-road travel assistive device of claim 1, further comprising a start condition determiner configured to determine whether the travel data satisfies a preset start condition for determining the stuck probability.

6. The off-road travel assistive device of claim 5, wherein the start condition is determined based on at least one of a steering angle of the vehicle, a current gear state of the vehicle, or a speed of the vehicle.

7. The off-road travel assistive device of claim 1, wherein the stuck probability determiner determines the stuck probability using a meta-model,
wherein the meta-model scores the stuck probability using at least one parameter determined by including at least one of a speed of the vehicle, a wheel slip rate of the vehicle, an accelerator open value of the vehicle, or road surface severity.

8. The off-road travel assistive device of claim 7, wherein the meta-model comprises a plurality of parameters determined by the speed of the vehicle, the wheel slip rate of the vehicle, the accelerator open value of the vehicle, and the road surface severity,
wherein the meta-model scores the stuck probability as a product of the plurality of parameters.

9. The off-road travel assistive device of claim 7, wherein the meta-model comprises a plurality of parameters determined by the speed of the vehicle, the wheel slip rate of the vehicle, the accelerator open value of the vehicle, and the road surface severity,
wherein the meta-model scores the stuck probability as a sum of the plurality of parameters.

10. The off-road travel assistive device of claim 7, wherein, when the vehicle is controlled to travel autonomously, the meta-model scores the stuck probability using the at least one parameter determined by including at least one of a speed of the vehicle, a wheel slip rate of the vehicle, an accelerator open value of the vehicle, or the road surface severity.

11. The off-road travel assistive device of claim 7, wherein the meta-model changes the at least one parameter that scores the stuck probability depending on a type of road surface on which the vehicle is traveling.

12. The off-road travel assistive device of claim 1, further comprising a post-processor configured to post-process the stuck probability determined by the stuck probability determiner using an exponential moving average (EMA).

13. The off-road travel assistive device of claim 12, wherein the post-processor applies a second exponential constant value when the stuck probability determined by the stuck probability determiner is greater than a preset score, and applies a first exponential constant value when the stuck probability determined by the stuck probability determiner is lower than the preset score,
wherein the first exponential constant value is set to be greater than the second exponential constant value.

14. The off-road travel assistive device of claim 1, further comprising a stuck mode determiner configured to apply a stuck mode based on a stuck probability score received from the stuck probability determiner.

15. The off-road travel assistive device of claim 14, further comprising a notification unit configured to inform a driver of a traveling status using at least one of a display or a sound,
wherein the stuck mode determiner informs the driver of the stuck probability through the notification unit when the stuck probability score is greater than a preset score.

16. The off-road travel assistive device of claim 14, wherein, in changing the stuck mode, the stuck mode determiner applies such that a reference score for changing from a lower stuck mode to an upper stuck mode is set to be higher than a reference score for changing from the upper stuck mode to the lower stuck mode,
wherein the upper stuck mode is a mode in which stuck occurrence probability is higher than the lower stuck mode.

17. An off-road travel assistive device comprising:
a receiver configured to receive travel data of a vehicle;
an estimator including road surface severity estimator configured to estimate road surface severity data based on the travel data of the vehicle; and
a stuck probability determiner configured to determine probability of a stuck state of the vehicle occurring by using the travel data and the road surface severity data,
wherein the stuck probability determiner determines the stuck probability using the travel data of the vehicle and the road surface severity data, and
wherein the travel data includes at least a speed of the vehicle, a wheel slip rate of the vehicle, or data regarding an accelerator open value of the vehicle.

18. The off-road travel assistive device of claim 17, wherein the travel data further comprises at least one of a steering angle of the vehicle, a current traveling gear ratio of the vehicle, or a type of road surface.

19. The off-road travel assistive device of claim 17, wherein the road surface severity estimator estimates the road surface severity as a score in a preset range based on stuck occurrence probability depending on a road surface condition.

20. The off-road travel assistive device of claim 17, wherein the estimator further comprises a traveling speed estimator configured to estimate an off-road traveling speed using a deep-learned wheel slip rate estimation model,
wherein the traveling speed estimator estimates a wheel slip rate using the travel data and the wheel slip rate estimation model, and estimates the off-road traveling speed using the estimated wheel slip rate, and
wherein the speed of the vehicle includes the off-road traveling speed.

21. The off-road travel assistive device of claim 17, further comprising a start condition determiner configured to determine the stuck probability using the stuck probability determiner only when the travel data satisfies a preset start condition,
wherein the start condition determiner does not determine the stuck probability when the vehicle travels with a sharp turn, travels in reverse, or stops.

22. The off-road travel assistive device of claim 17, wherein the stuck probability determiner scores the stuck probability using at least one parameter determined by including at least one of the speed of the vehicle, the wheel slip rate of the vehicle, the accelerator open value of the vehicle, or the road surface severity.

23. The off-road travel assistive device of claim 17, further comprising a post-processor configured to reflect the stuck probability determined in a past to the stuck probability determined by the stuck probability determiner, and post-process a result therefrom.
